(19) United States
(12) Patent Application Publication
(10) Pub. No.: US 2016/0192616 A1
(43) Pub. Date: Jul. 7, 2016

(54) MODULAR DOG HOUSE

(71) Applicant: Mark Rusty Kitchen, Fruit Heights, UT (US)

(72) Inventor: Mark Rusty Kitchen, Fruit Heights, UT (US)

(21) Appl. No.: 15/044,773

(22) Filed: Feb. 16, 2016

(51) Int. Cl. A01K 1/035; A01K 1/00

(52) U.S. Cl. CPC A01K 1/035; A01K 1/0064

(57) ABSTRACT

The embodiments herein provide a modular dog house having a kennel/living area and a dog run. The kennel comprises four side walls, a base, a porch and a roof. The kennel kept is kept at an elevated level from the ground level. The dog run attached to the front side of kennel is extended underneath the kennel thereby increasing the area of the dog run. The kennel includes a large personal access door for providing full access to interior area and a vinyl flap door for providing access to the porch and the dog run for the dog. A ramp having cleats is attached to the porch for providing footing to climb up and down the kennel.

### BACKGROUND

1. Technical Field

The embodiments herein are generally related to cages/housings for pet animals. The embodiments herein are particularly related to a dog kennel. The embodiments herein are more particularly related to a dog kennel with large exercise area and enclosure for dogs. The embodiments herein are especially related to a dog kennel capable of enhancing living area and ensuring clean living space simultaneously

2. Description of the Related Art

A kennel is a shelter for pets like dogs, cats, rabbits etc. The kennel is made of rigid structures made of wood, plastic or other materials, and provided with four walls resting on a base and closed at the top by a roof. The kennels are available with removable parts thereby enabling the user to easily assemble and dismantle the kennels. Nowadays, a wide variety of designs for kennels are available throughout the world. However most of the designs have several common problems.

In most of the currently available designs, the walls of the kennels are configured to rest on a base kept on the ground level. Therefore, the kernel suffers from unhygienic conditions as water seeps in to the base during rain and the floor remains wet and dirty. Further, the small doors of the kennel make the cleaning process difficult for a person. Most kennel design have nowadays a runway attached to the kernel to provide an exercise area for the dogs. The runway further enables the individual to perform the house keeping services kennel even before boarding the kennel with dogs. The housekeeping services of the kennel includes grooming, washing, feeding and exercising. However, the kennel for dogs of large breeds becomes congested compared to that of smaller breeds.

Hence, there is a need for a modular dog house for the dogs of larger breeds. Further, there is a need for a modular dog house designed to maximize the kennel space. Yet further, there is also a need for maintaining a clean living are/space and safe environment in the modular dog house. Still further, there is also a need for a modular dog house designed to maximise the running space in the modular dog house, thereby providing an ultimate playground environment for the dog.

The above mentioned shortcomings, disadvantages and problems are addressed herein and which will be understood by reading and studying the following specification.

### OBJECTS OF THE EMBODIMENTS

The primary object of the embodiments herein is to provide a modular dog housing with a living area at an elevated level from the ground, thereby providing the dogs with a clean living space and a safe environment.

Another object of the embodiments herein is to provide a modular dog house with a living area and a porch at an elevated position from the ground for providing an extra square footage in the kennel.

Yet another object of the embodiments herein is to provide a modular dog house at an elevated position from the ground, thereby increasing the run space underneath the dog house without taking up additional valuable space.

Yet another object of the embodiments herein is to provide a modular dog house with a living area attached with a dog run which is extended underneath the dog house, thereby increasing the area of the dog run.

Yet another object of the embodiments herein is to provide a modular dog house with a capability for expanding the area of the dog run as desired by a user.

Yet another object of the embodiments herein is to provide a modular dog house with a living area provided with four walls, roof and flooring insulated for an optimum comfortable temperature.

Yet another object of the embodiments herein is to provide a modular dog house with a living area having a large door at an offset position, thereby providing a full access to the inside area for easy cleaning and reaching out accessories in a dog house.

Yet another object of the embodiments herein is to provide a modular dog house with a ramp for accessing the front door and porch.

Yet another object of the embodiments herein is to provide a modular dog house with a ramp equipped with cleats for providing proper footing for climbing up to the porch.

Yet another object of the embodiments herein is to provide a modular dog house with a transparent vinyl flap door at the front side of the living area, for exposing and irradiating the dog house with sunlight/radiations.

Yet another object of the embodiments herein is to provide a modular dog house with a vinyl flap door for maintaining an inner area at a warm condition by holding hot air inside and insulating inner hot air from cold outside air.

Yet another object of the embodiments herein is to provide a modular dog house mounted on a frame made of steel and coated with powder, thereby forming a durable, rust proof and heavy-duty dog house with a long shell life.

Yet another object of the embodiments herein is to provide a modular dog house with a dog run built with welded wire mesh gauge, thereby preventing the dogs from chewing the parts.

Yet another object of the embodiments herein is to provide a modular dog house having simulated shingled roofing with steep pitch for quick drainage of rain and snow.

These and other objects and advantages of the embodiments herein will become readily apparent from the following detailed description taken in conjunction with the accompanying drawings.

### SUMMARY

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

The various embodiments herein provide a modular dog house with a living area and a dog run. The kennel/living area is elevated from the ground using steel frames. The kennel/living area comprises four side walls, a porch, a base and a roof. The elevated structure of the kennel/living area provides a safe and hygienic environment for the dog. The dog run is attached to the front side of the kennel/living area. The dog run provides a play area for the dogs. The elevated structure of the kennel/living area provides an extended dog run underneath the kennel/living area. Therefore, the area of the modular dog house is greatly increased. Further, the modular dog house comprise a ramp for providing perfect footing to climb up to the porch and climb down to the dog run.

According to an embodiment herein, a modular dog house includes a kennel/living area, a dog run, a ramp, a personal access door, a vinyl flap door. The kennel/living area is positioned at a particular height from ground. The kennel/living area comprises a front side wall, a rear side wall, a left side wall, a right side wall, a porch, a base and a roof. The dog run is attached to the front side of the kennel/living area and extended underneath the living area. The ramp is equipped with cleats for providing grip to enable a dog to climb up to the porch. One end of the ramp is attached to the porch and other end is attached to the ground. The personal access door is placed at the left side wall for providing full access to inside area of the kennel/living area. The size of the personal access door is nearly equal to the size of the left side wall. The vinyl flap door is placed at the front side wall for enabling the dog to move to the porch and the dog run.

According to an embodiment herein, the kennel/living area is filled with insulation at inside surface of the front side wall, the rear side wall, the left side wall, the right side wall, the base and the roof for providing an optimum temperature inside the kennel/living area.

According to an embodiment herein, the modular dog house is supported on a steel frame.

According to an embodiment herein, the dog run is built by attaching two panels made of welded wire mesh gauge on both sides of the front side wall.

According to an embodiment herein, the dog run is expanded by attaching additional panels to the existing dog run.

According to an embodiment herein, the roof is a simulated shingled roof with a steep pitch for draining snow and rain.

According to an embodiment herein, the front side wall comprises a first vent and the rear side wall comprises a second vent. The first vent and the second vent are configured to provide cross ventilation inside the kennel dog house.

According to an embodiment herein, the dog run is extended underneath the kennel/living area to provide an extra square footage in the modular dog house.

According to an embodiment herein, the vinyl flap door is a transparent flap door for entry of sunlight to the kennel/living area to expose and irradiating the living area with sunlight.

According to an embodiment herein, the magnetic strip of the vinyl flap door is attached at the bottom to ensure a proper closing of the door.

According to an embodiment herein, the modular dog house is converted to small animal house by changing the ramp with a multi layer step.

According to an embodiment herein, the modular dog house is converted to a chicken coop by adding features to the rear side wall with a rear side.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

### BRIEF DESCRIPTION OF THE DRAWINGS

The other objects, features and advantages will occur to those skilled in the art from the following description of the preferred embodiment and the accompanying drawings in which:

FIG. 1A illustrates a top side perspective view of a modular dog house, according to one embodiment herein.

FIG. 1B illustrates a side view of a modular dog house, according to one embodiment herein.

FIG. 2A illustrates a front side perspective view of a modular dog house, according to one embodiment herein.

FIG. 2B illustrates a front side view of a modular dog house with side panels of the dog run in removed condition, according to one embodiment herein.

FIG. 2C illustrates a top side view of a modular dog house, according to one embodiment herein.

FIG. 3A illustrates a front side perspective view of a kennel/living room in a modular dog house, according to one embodiment herein.

FIG. 3B illustrates an exploded assembly view of a kennel/living room in a modular dog house, according to one embodiment herein.

FIG. 3C illustrates a right side view of a kennel/living room in a modular dog house, according to one embodiment herein.

FIG. 3D illustrates front side view of a kennel/living room in a modular dog house, according to one embodiment herein.

FIG. 3E illustrates a left side view of a kennel/living room in a modular dog house, according to one embodiment herein.

FIG. 3F illustrates a top side view of a kennel/living room in a modular dog house, according to one embodiment herein.

FIG. 3G illustrates a rear view of a kennel/living room in a modular dog house, according to one embodiment herein.

FIG. 4A illustrates a front view of the left side wall a kennel/living room in a modular dog house, according to one embodiment herein.

FIG. 4B illustrates a side view of the left side wall a kennel/living room in a modular dog house, according to one embodiment herein.

FIG. 4C illustrates a rear view of the left side wall a kennel/living room in a modular dog house, according to one embodiment herein.

FIG. 4D illustrates a front side view of the left side wall a kennel/living room in a modular dog house, according to one embodiment herein.

FIG. 4E illustrates a front view of the left side wall with the personal access door in closed condition in a kennel/living room in a modular dog house, according to one embodiment herein.

FIG. 4F illustrates a side view of the personal access door, in a kennel/living room in a modular dog house, according to one embodiment herein.

FIG. 4G illustrates a rear view of the personal access door, in a kennel/living room in a modular dog house, according to one embodiment herein.

FIG. 4H illustrates a front side view of the personal access door, a kennel/living room in a modular dog house, according to one embodiment herein.

FIG. 4I illustrates a front view of the right side wall 306 in a kennel/living room in a modular dog house, according to one embodiment herein.

FIG. 4J illustrates a front side view of the right side wall in a kennel/living room in a modular dog house, according to one embodiment herein.

FIG. 4K illustrates a rear view of the right side wall in a kennel/living room in a modular dog house, according to one embodiment herein.

FIG. 4L illustrates a side view of the right side wall in a kennel/living room in a modular dog house, according to one embodiment herein.

FIG. 4M illustrates a front view of the front side wall in a kennel/living room in a modular dog house, according to one embodiment herein.

FIG. 4N illustrates a front side view of the front side wall in a kennel/living room in a modular dog house, according to one embodiment herein.

FIG. 4O illustrates a rear view of the front side wall in a kennel/living room in a modular dog house, according to one embodiment herein.

FIG. 4P illustrates a side view of the front side wall in a kennel/living room in a modular dog house, according to one embodiment herein.

FIG. 4Q illustrates a front view of the rear side wall in a kennel/living room in a modular dog house, according to one embodiment herein.

FIG. 4R illustrates a front side view of the rear side wall in a kennel/living room in a modular dog house, according to one embodiment herein.

FIG. 4S illustrates a side view of the rear side wall in a kennel/living room in a modular dog house, according to one embodiment herein.

FIG. 5A illustrates the top side perspective view of a chicken coop, according to one embodiment herein.

FIG. 5B illustrates the side view of a chicken coop, according to one embodiment herein.

FIG. 5C illustrates the front side view of a chicken coop, according to one embodiment herein.

FIG. 5D illustrates the rear side view of a chicken coop, according to one embodiment herein.

FIG. 5E illustrates the top side view of a chicken coop, according to one embodiment herein.

FIG. 6A illustrates the front view of the rear side wall of a chicken coop, according to one embodiment herein.

FIG. 6B illustrates the front side view of the rear side wall of a chicken coop, according to one embodiment herein.

FIG. 6C illustrates the side view of the rear side wall of a chicken coop, according to one embodiment herein.

FIG. 6D illustrates the front view of the rear side wall with nesting box in a chicken coop, according to one embodiment herein.

FIG. 6E illustrates the side view of the rear side wall with a nesting box in a chicken coop, according to one embodiment herein.

FIG. 6F illustrates the side view of the rear side wall with a nesting box in a chicken coop, according to one embodiment herein.

FIG. 6G illustrates the front side view of the rear side wall with a nesting box in a chicken coop, according to one embodiment herein.

FIG. 6H illustrates the rear view of the front side wall of a chicken coop, according to one embodiment herein.

Although the specific features of the embodiments herein are shown in some drawings and not in others. This is done for convenience only as each feature may be combined with any or all of the other features in accordance with the embodiments herein.

### DETAILED DESCRIPTION OF THE EMBODIMENTS

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

The various embodiments herein provide a modular dog house with a living area and a dog run. The kennel/living area is elevated from the ground using steel frames. The kennel/living area comprises four side walls, a porch, a base and a roof. The elevated structure of the kennel/living area provides a safe and hygienic environment for the dog. The dog run is attached to the front side of the kennel/living area. The dog run provides a play area for the dogs. The elevated structure of the kennel/living area provides an extended dog run underneath the kennel/living area. Therefore, the area of the modular dog house is greatly increased. Further, the modular dog house comprise a ramp for providing perfect footing to climb up to the porch and climb down to the dog run.

According to an embodiment herein, a modular dog house includes a kennel/living area, a dog run, a ramp, a personal access door, a vinyl flap door. The kennel/living area is positioned at a particular height from ground. The kennel/living area comprises a front side wall, a rear side wall, a left side wall, a right side wall, a porch, a base and a roof. The dog run is attached to the front side of the kennel/living area and extended underneath the living area. The ramp is equipped with cleats for providing grip to enable a dog to climb up to the porch. One end of the ramp is attached to the porch and other end is attached to the ground. The personal access door is placed at the left side wall for providing full access to inside area of the kennel/living area. The size of the personal access door is nearly equal to the size of the left side wall. The vinyl flap door is placed at the front side wall for enabling the dog to move to the porch and the dog run.

According to an embodiment herein, the kennel/living area is filled with insulation at inside surface of the front side wall, the rear side wall, the left side wall, the right side wall, the base and the roof for providing an optimum temperature inside the kennel/living area.

According to an embodiment herein, the modular dog house is supported on a steel frame.

According to an embodiment herein, the dog run is built by attaching two panels made of welded wire mesh gauge on both sides of the front side wall.

According to an embodiment herein, the dog run is expanded by attaching additional panels to the existing dog run.

According to an embodiment herein, the roof is a simulated shingled roof with a steep pitch for draining snow and rain.

According to an embodiment herein, the front side wall comprises a first vent and the rear side wall comprises a second vent. The first vent and the second vent are configured to provide cross ventilation inside the kennel dog house.

According to an embodiment herein, the dog run is extended underneath the kennel/living area to provide an extra square footage in the modular dog house.

According to an embodiment herein, the vinyl flap door is a transparent flap door for entry of sunlight to the kennel/living area to expose and irradiating the living area with sunlight.

According to an embodiment herein, the magnetic strip of the vinyl flap door is attached at the bottom to ensure a proper closing of the door.

According to an embodiment herein, the modular dog house is converted to small animal house by changing the ramp with a stair case.

According to an embodiment herein, the modular dog house is converted to a chicken coop by adding features to the rear side wall with a rear side.

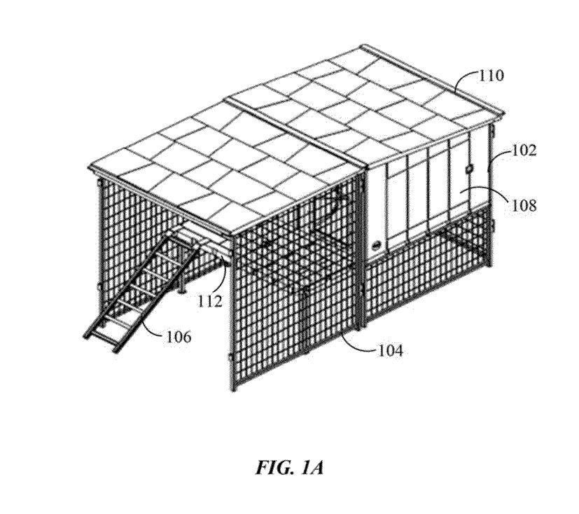

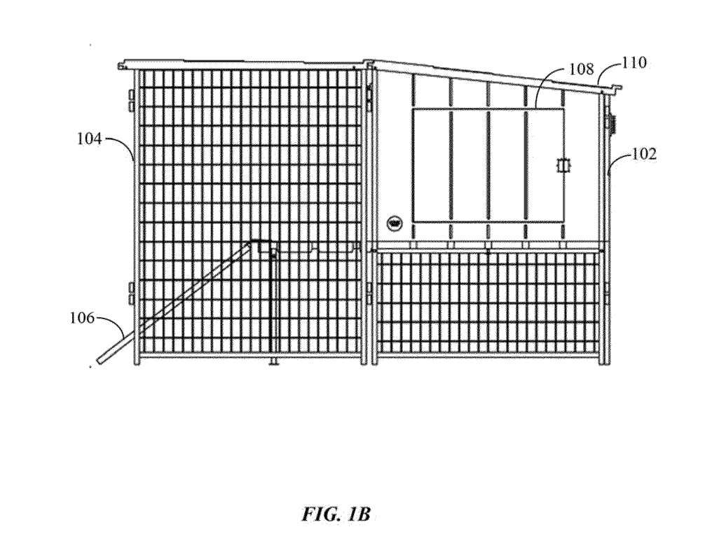

FIG. 1A illustrates a top side perspective view of a modular dog house, according to one embodiment herein. FIG. 1B illustrates a side view of a modular dog house, according to one embodiment herein. With respect to the FIG. 1A and FIG. 1B, the modular dog house comprises a kennel/living area 102, a dog run 104, a ramp 106, and a personal access door 108. The kennel/living area 102 comprises four side walls, and a base. The kennel/living area 102 further comprises a roof 110, a porch 112. The four side walls of the kennel/living area 102 is made of maintenance free materials including but not limited to polyethylene plastic. According to one embodiment herein, the four side walls are made of 2 inch double-walled polyethylene plastic that is insulated with steel reinforcement powder coated frame, thereby making the four side walls are rust-proof and corrosion resistant.

The four sides of the walls are fitted to a frame of the modular dog house. The frame is made of steel and is powder coated. The frames of the modular dog house are chew resistant. The four sides of the wall, the base and the roof 110 are insulated to sustain an optimum comfortable temperature in the kennel/living area 102. According to one embodiment herein, the insulation is provided by filling the four sides of the wall, the floor and the roof 110 with 2 inch insulation material. The insulated kennel/living area 102 keeps the dog comfortable during winter season and summer season. The kennel/living area 102 is elevated off from the ground level. The kennel/living area 102 is supported with the frame. The elevated structure prevents the water seeping inside the kennel/living area 102 and wetting the floor. The elevated kennel/living area 102 provides the dog with a hygienic environment.

The dog run 104 is attached on the front side of the kennel/living area 102. As the kennel/living area is elevated from the ground, the dog run is extended underneath the kennel/living area 102. The extended dog run 104 provides a shelter for the dogs from sunlight and rain. The dog run 104 is built by attaching the panels to both sides of the front side wall of the kennel/living area 102. The panels are made of welded wire gauge mesh. The welded wire gauge is a heavy duty 6 gauge 2″×4″ spacing welded wire. Further, the modular dog house comprises a ramp 106 attached to the porch of the kennel/living area 102. The ramp 106 is equipped with cleats for providing/resting the footing to climb up to the porch. The ramp 106 enables the dog to climb up to the kennel/living area 102 and climb down to the dog run 104. According to one embodiment herein, the length of the ramp 106 is four feet.

The modular dog house further includes the personal access door 108. The personal access 108 door is fixed at an offset position. The personal access door 108 is fitted to one of the left side wall and right side wall of the kennel/living area 102. The personal access door 108 is nearly equal in size of the side wall of the kennel/living area 102. Therefore, the kennel/living area enables an individual to have full access to the inside area of the kennel/living area 102. The personal access door 108 enables the individuals to reach out the materials inside the kennel/living area 102 with ease. As the kennel/living area 102 is elevated from the ground, the personal access door 108 appears to be located/positioned at a particular height from the ground. Therefore, the individual is enabled to reach the things inside the kennel dog house 102 by standing on foot, thereby eliminating the need of bending down or standing on knees.

The personal access door 108 enables the individual to check the dog and puppies in the kennel/living area without requiring much effort. Further, the size of the personal access door 108 enables the individual to take out a large sized things including the dog's bed, food bowl etc. Further, the personal access door 108 enables the individual to clean the dirt in the dog house properly. The personal access door 108 is provided with a facility/provision to install a pad lock. Therefore, the personal access door 108 is locked easily thereby preventing any external individual from accidentally opening and letting the dog out of the modular dog house.

The kennel/living area 102 also includes a vinyl flap door fitted at the front side wall. The vinyl flap door includes a magnetic strip to enable a proper closing and locking of the vinyl flap door, thereby ensuring a maintenance and holding of the warm air inside and cold air outside the kennel/living area 102. The vinyl flap door is transparent to allow the sunlight into the kennel/living area. Further the vinyl flap door is transparent enough or provides visibility for the dog to move to the porch 112 and the dog run easily. The kennel/living area 102 comprises a roof 110. The roof 110 is a simulated shingled roof with steep pitch allowing a proper drainage of rain and snow. Further, the roof 110 is provided with insulation for warmth on cold winter nights.

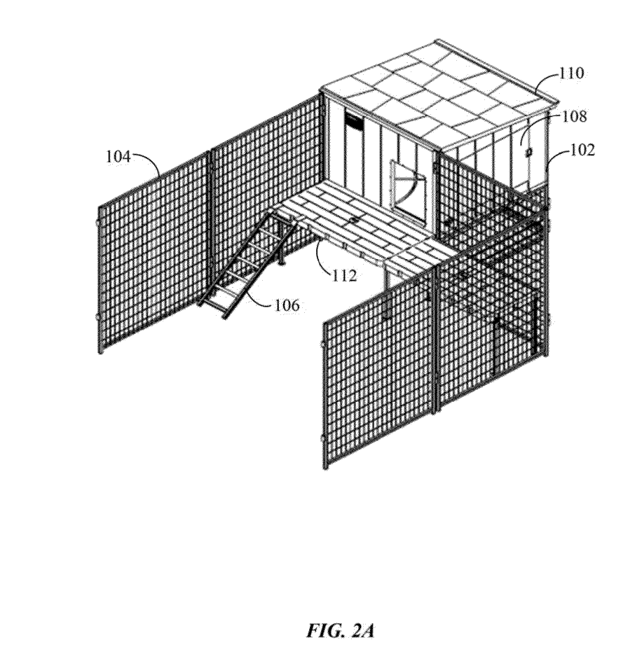

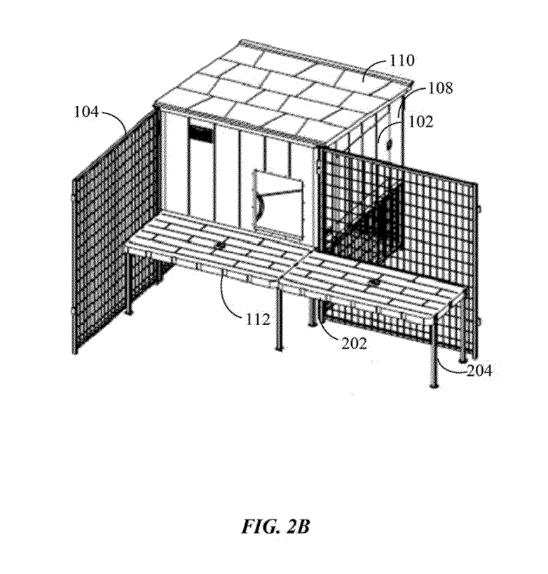

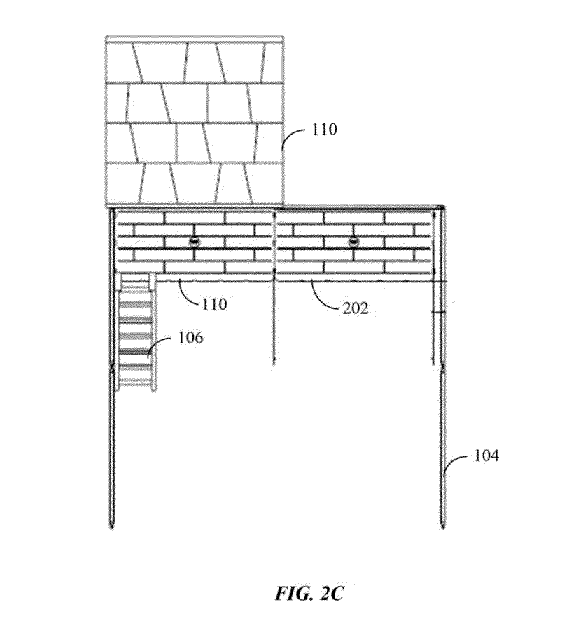

FIG. 2A illustrates a front side perspective view of a modular dog house, according to one embodiment herein. FIG. 2B illustrates a front side view of a modular dog house with side panels of the dog run in removed condition, according to one embodiment herein. FIG. 2C illustrates a top side view of a modular dog house, according to one embodiment herein. With respect to FIG. 2A-FIG. 2C, the modular dog house is provided with an extendable/expandable dog run. The modular dog house design enables an individual to expand the length and width of dog run 104. The dog run 104 is built by attaching the panels to both sides of a front side wall of the kennel/living area 102. According to one embodiment herein, the dog run 104 is made of 1″×1″ steel tube. The dog run 104 is expanded/extended by fitting additional panels. The length of the dog run 104 is expanded by fitting additional panels to the exiting panels of the dog run 104. The length of the dog run 104 is doubled by fitting two additional panels to each existing panels on each side of the dog run 104.

Further, the width of the dog run 104 is expanded/extended as shown on FIG. 2A by increasing the length of a porch 112 of the kennel/living area 102. The length of the porch 112 is increased by fitting an extra piece of same material (wood) of the porch to the existing porch 112 of the kennel/living area 102. The extra wooden piece 202 is fitted by fixing an additional steel frame 204 on the ground. Further, the additional panels and the extra wooden piece 202 are fitted to the dog run, to increase the width of the dog run. Further, the expanded/extended dog run is provided with roofing (not shown in FIG), to cover the entire dog run 104. The roofing of the dog run is made of steel material. The roofing of the dog run provides a protected environment with shade from sunlight and shelter from outside predators.

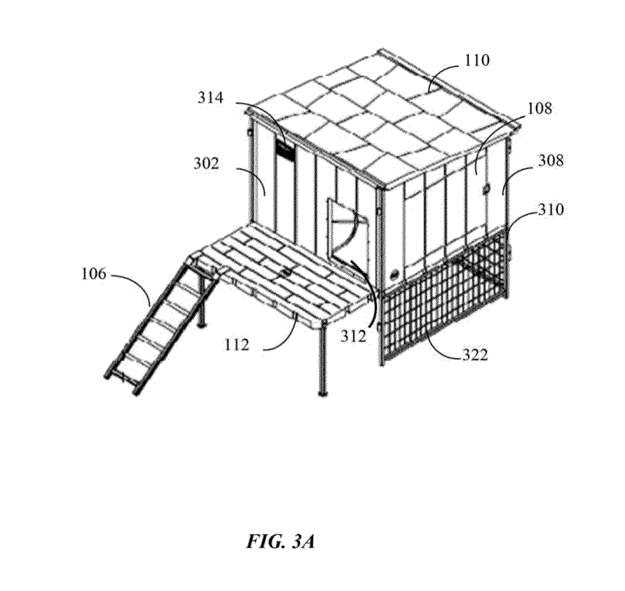

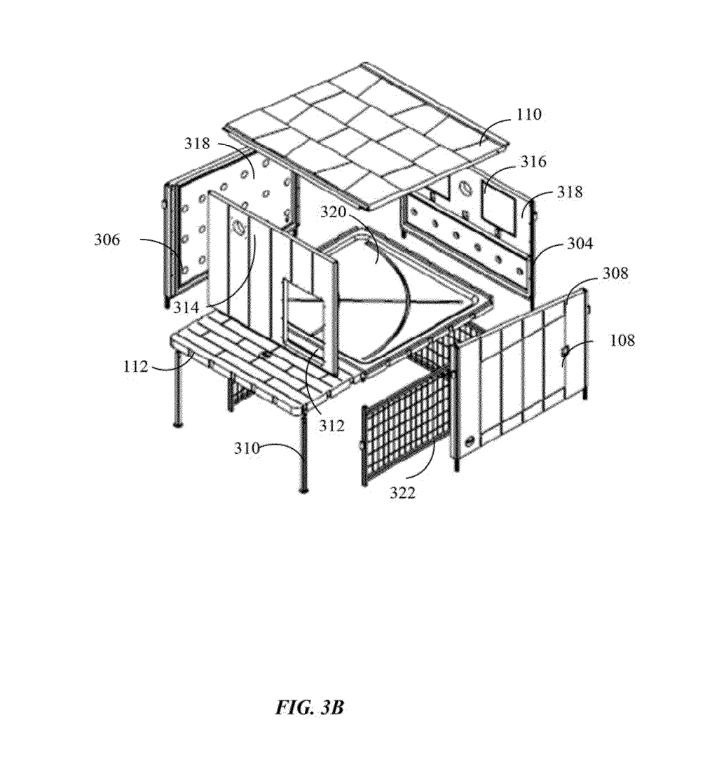

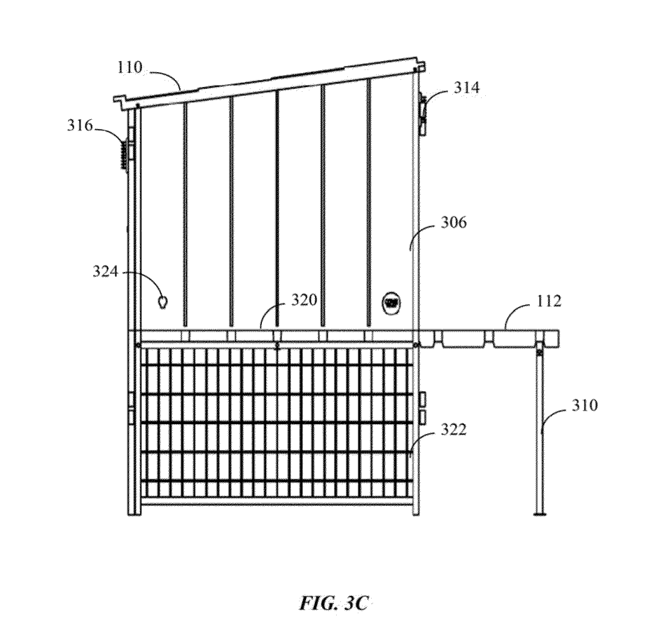

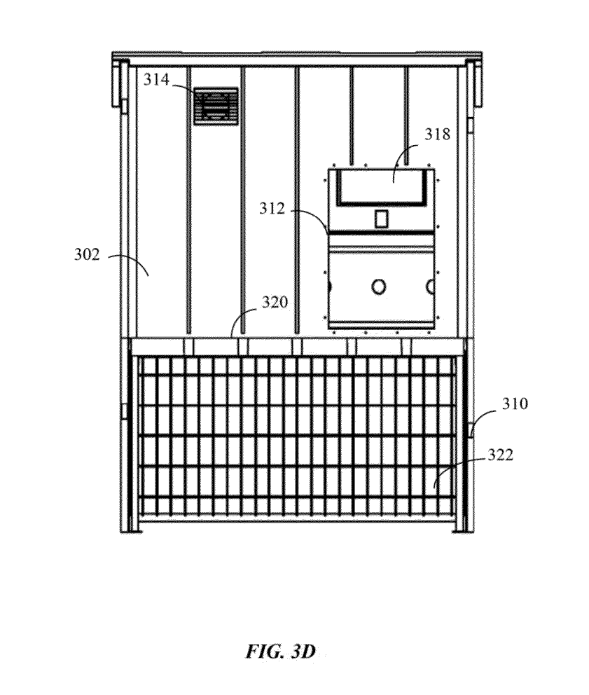

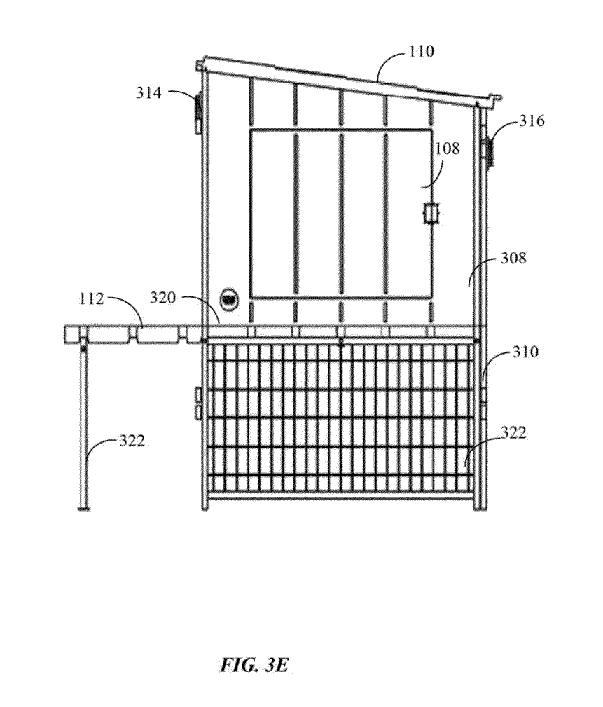

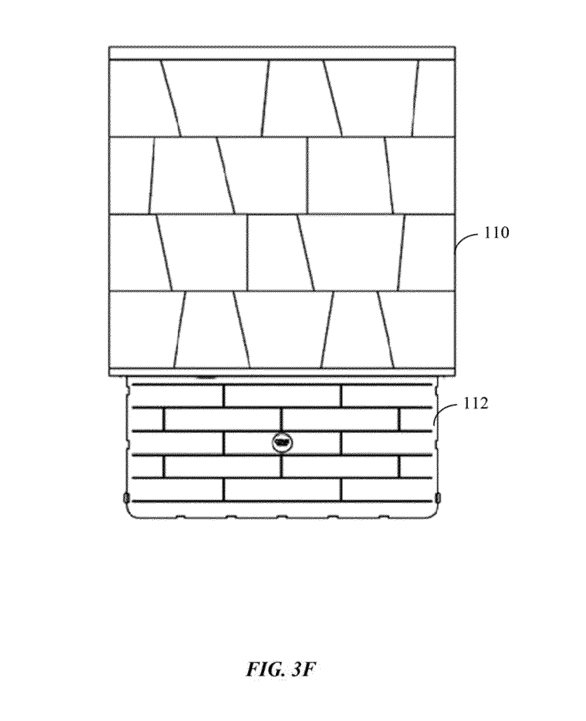

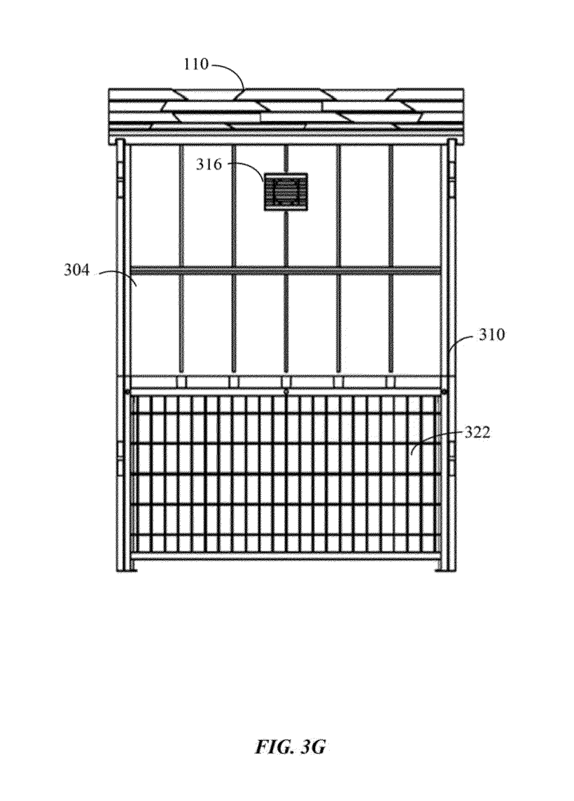

FIG. 3A illustrates a front side perspective view of a kennel/living room in a modular dog house, according to one embodiment herein. FIG. 3B illustrates an exploded assembly view of a kennel/living room in a modular dog house, according to one embodiment herein. FIG. 3C illustrates a right side view of a kennel/living room in a modular dog house, according to one embodiment herein. FIG. 3D illustrates front side view of a kennel/living room in a modular dog house, according to one embodiment herein. FIG. 3E illustrates a left side view of a kennel/living room in a modular dog house, according to one embodiment herein. FIG. 3F illustrates a top side view of a kennel/living room in a modular dog house, according to one embodiment herein. FIG. 3G illustrates a rear view of a kennel/living room in a modular dog house, according to one embodiment herein. With respect to FIG. 3A-FIG. 3G, the different parts of the kennel/living area 102 in a modular dog house comprises four side walls a roof 110, a porch 112, and a base 320. The four side walls of the kennel/living area 102 comprises a front side wall 302, a rear side wall 304, a right side wall 306, a left side wall 308. The kennel/living area 102 is supported on a steel frame 310. The steel frame 310 is chew resistant. The steel frame 310 comprises four legs for holding the kennel/living area 102 at an elevated position/condition from the ground. The steel frame holds the four side walls of the kennel/living area 102. The four side walls of the kennel/living area 102 is made of maintenance free materials including but not limited to polyethylene plastic.

The front side wall 302 comprises a vinyl flap door 312. The vinyl flap door 312 comprises a magnet on one end for ensuring a proper closing of the vinyl flap door 312, thereby keeping the warm air inside and preventing the cold air from entering inside the kennel/living area 102. Once the dog exit the kennel/living area 102, the vinyl flap door 312 comes back to the closing position. The vinyl flap door 312 is made of transparent material to allow the sunlight to enter inside the kennel dog house 102. The vinyl flap door 312 enables the dog to view the outside space and dog run from inside the kennel dog house 102. The front side wall 302 comprises a first vent 314. The rear side wall 304 comprises a second vent 316. The first vent 314 and the second vent 316 are arranged and configured to provide a cross ventilation in the kennel/living area 102. The first vent 314 and the second vent 316 are kept closed during the winter and opened during the summer.

The right side wall 306 comprises an electrical chord hole 324 at one corner. The electrical chord hole 324 allows an electrical chord of the heater to exit directly from the side wall of the kennel/living area 102. The left side wall 308 comprises a personal access door 108. The personal access door 108 is nearly equal in size to that of the left side wall 308. Thus the personal access door 108 enables an individual to have a full access to the inside area of the kennel/living area 102. As the kennel/living area 102 is in an elevated condition from the ground level, the personal access door 108 is also kept at an elevated condition and is positioned at a preset height. Hence, the individual is enabled to reach the things arranged inside kennel/living area 102 by standing on foot, thereby eliminating a need for bending down or standing on knees. Further, the personal access door 108 enables the individual to check the presence of dog inside the kennel/living area 102 and to make arrangements for cleaning the dirt in the kennel/living area 102 properly. The four sides of the wall, the base 320 and the roof 110 are covered with an insulation material 318 to sustain an optimum comfortable temperature in the kennel/living area 102.

Further, the lower portion of the base 320 of the kennel/living area 102 is configured to act as an extended dog run. The dog run of the modular dog house is extended underneath the kennel/living area 102. The dog run is extended by attaching the panels on the steel frame under the left side wall 306, the right sidewall 308 and the rear side wall 304. The panels are welded wire gauge mesh 322, thereby making the panels chew resistant. The extended run under the kennel/living area 102 is configured to provide shade and shelter from the sun. The dog run is extended underneath the kennel/living area to prevent the water and dirt from seeping inside the kennel/living area 102.

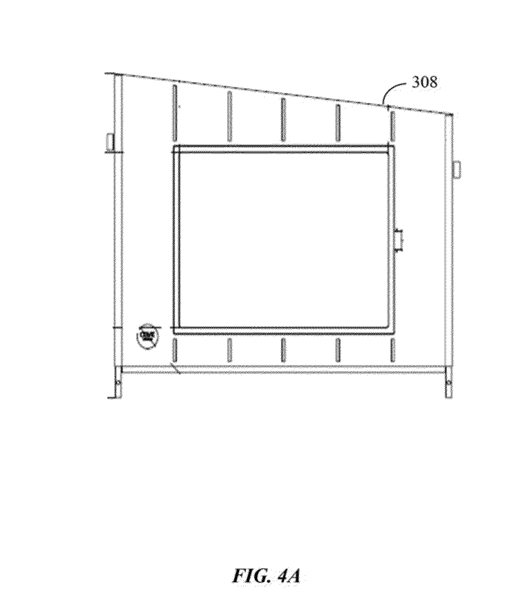

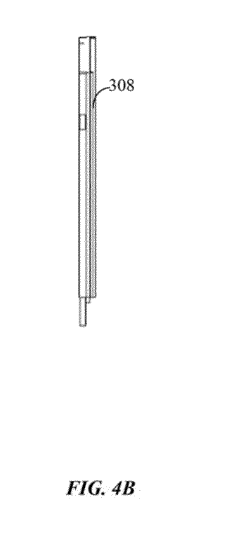

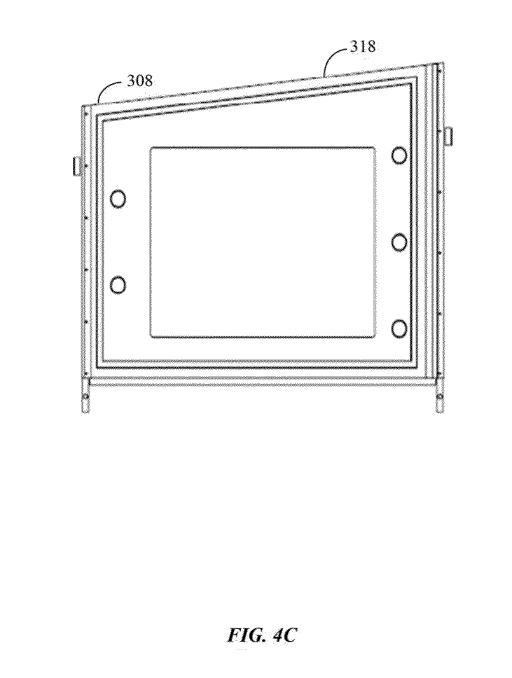

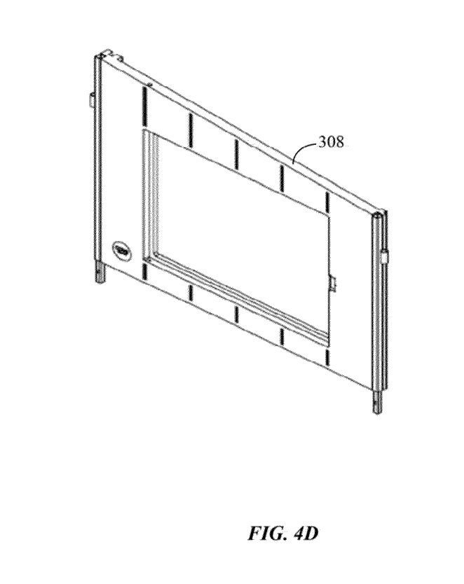

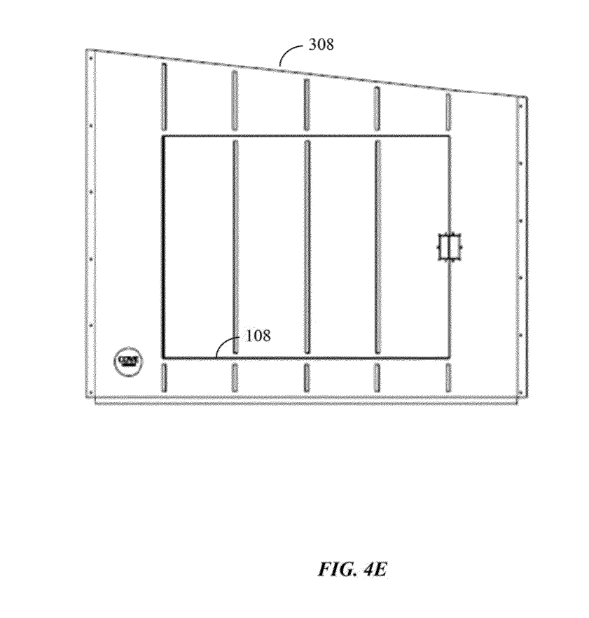

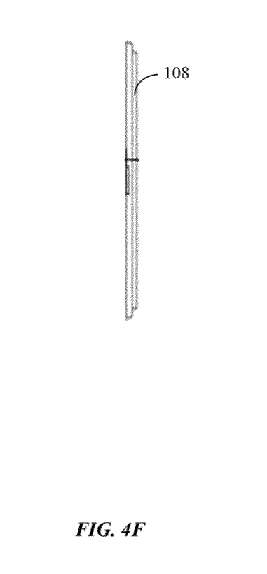

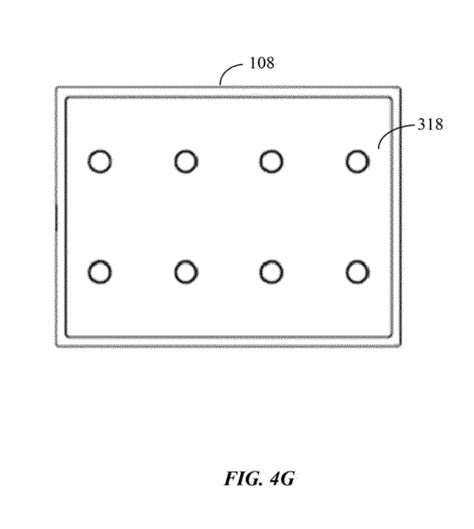

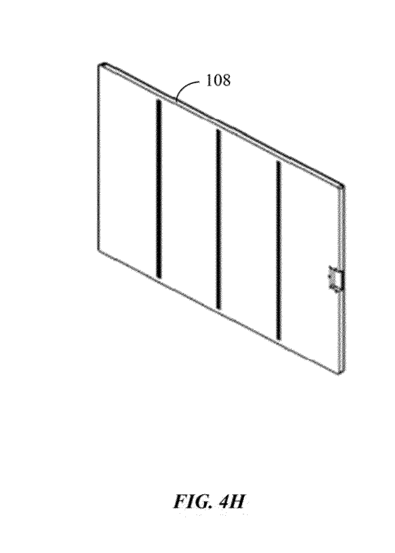

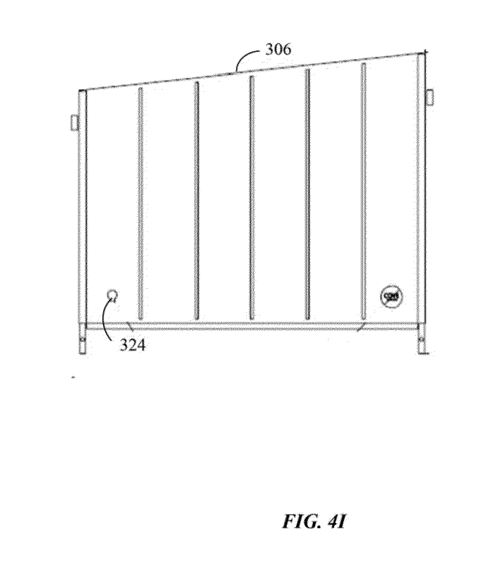

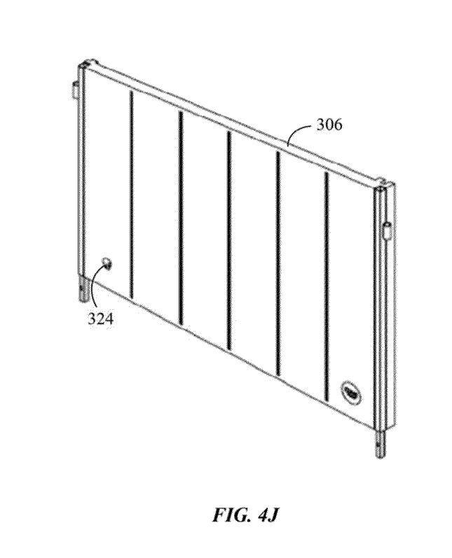

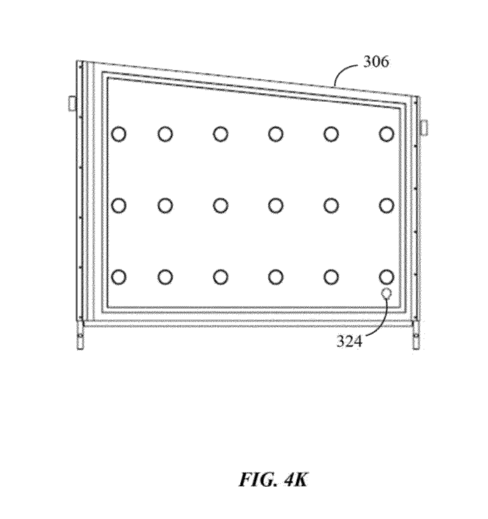

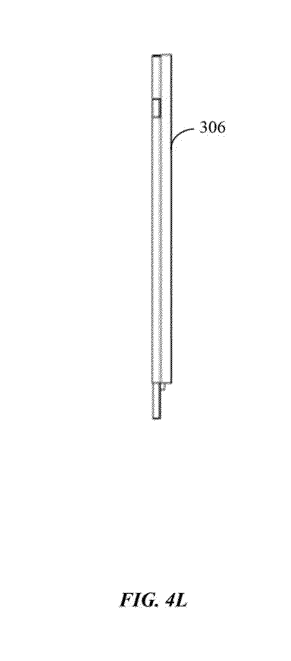

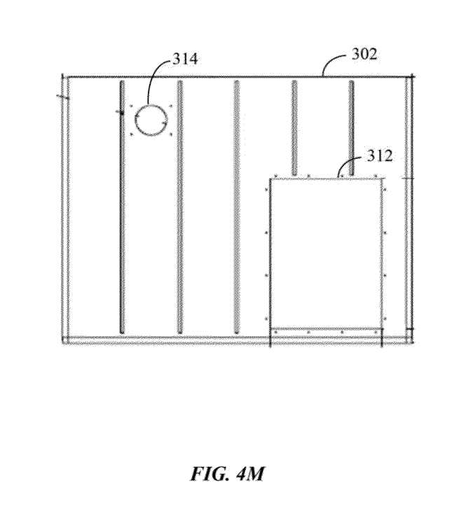

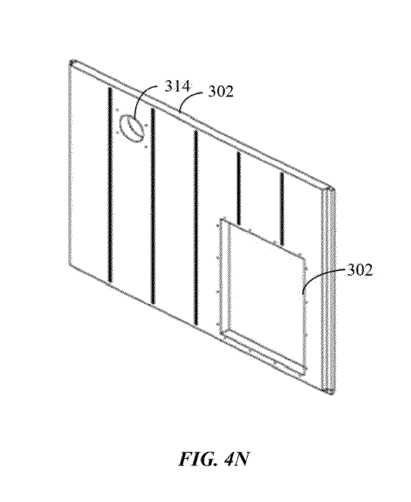

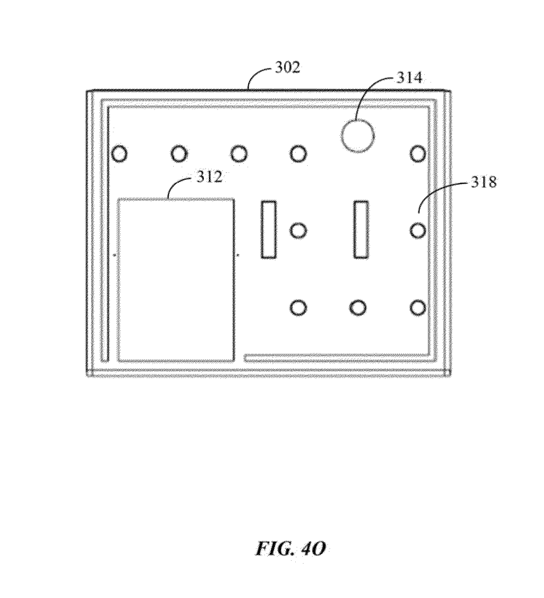

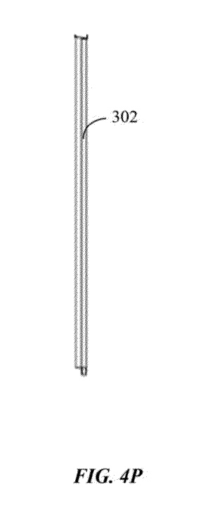

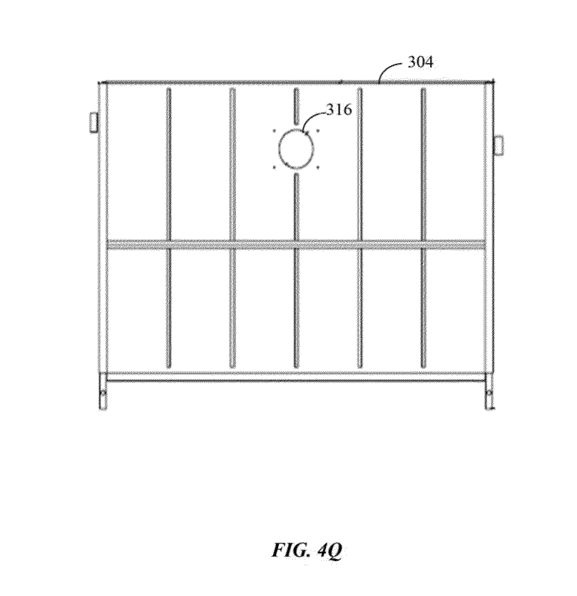

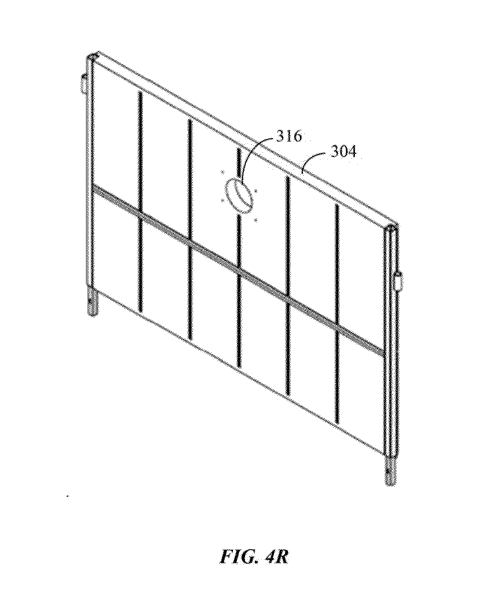

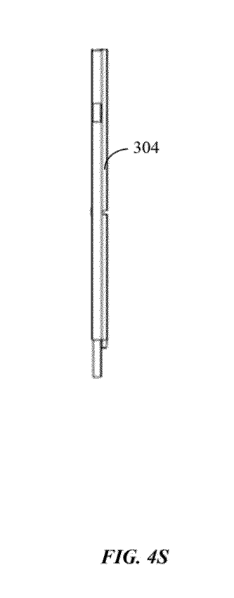

FIG. 4A illustrates a front view of the left side wall a kennel/living room in a modular dog house, according to one embodiment herein. FIG. 4B illustrates a side view of the left side wall a kennel/living room in a modular dog house, according to one embodiment herein. FIG. 4C illustrates a rear view of the left side wall a kennel/living room in a modular dog house, according to one embodiment herein. FIG. 4D illustrates a front side view of the left side wall a kennel/living room in a modular dog house, according to one embodiment herein. FIG. 4E illustrates a front view of the left side wall with the personal access door in closed condition in a kennel/living room in a modular dog house, according to one embodiment herein. FIG. 4F illustrates a side view of the personal access door, in a kennel/living room in a modular dog house, according to one embodiment herein. FIG. 4G illustrates a rear view of the personal access door, in a kennel/living room in a modular dog house, according to one embodiment herein. FIG. 4H illustrates a front side view of the personal access door, a kennel/living room in a modular dog house, according to one embodiment herein. FIG. 4I illustrates a front view of the right side wall 306 in a kennel/living room in a modular dog house, according to one embodiment herein. FIG. 4J illustrates a front side view of the right side wall in a kennel/living room in a modular dog house, according to one embodiment herein. FIG. 4K illustrates a rear view of the right side wall in a kennel/living room in a modular dog house, according to one embodiment herein. FIG. 4L illustrates a side view of the right side wall in a kennel/living room in a modular dog house, according to one embodiment herein. FIG. 4M illustrates a front view of the front side wall in a kennel/living room in a modular dog house, according to one embodiment herein. FIG. 4N illustrates a front side view of the front side wall in a kennel/living room in a modular dog house, according to one embodiment herein. FIG. 4O illustrates a rear view of the front side wall in a kennel/living room in a modular dog house, according to one embodiment herein. FIG. 4P illustrates a side view of the front side wall in a kennel/living room in a modular dog house, according to one embodiment herein. FIG. 4Q illustrates a front view of the rear side wall in a kennel/living room in a modular dog house, according to one embodiment herein. FIG. 4R illustrates a front side view of the rear side wall in a kennel/living room in a modular dog house, according to one embodiment herein. FIG. 4S illustrates a side view of the rear side wall in a kennel/living room in a modular dog house, according to one embodiment herein.

With respect to FIG. 4A-FIG. 4S, the different parts of the kennel/living area 102 in a modular dog house comprises four side walls a roof 110, a porch 112, and a base 320. The four side walls of the kennel/living area 102 comprises a front side wall 302, a rear side wall 304, a right side wall 306, a left side wall 308. The kennel/living area 102 is supported on a steel frame 310. The steel frame 310 is chew resistant. The steel frame 310 comprises four legs for holding the kennel/living area 102 at an elevated position/condition from the ground. The steel frame holds the four side walls of the kennel/living area 102. The four side walls of the kennel/living area 102 is made of maintenance free materials including but not limited to polyethylene plastic.

The front side wall 302 comprises a vinyl flap door 312. The vinyl flap door 312 comprises a magnet on one end for ensuring a proper closing of the vinyl flap door 312, thereby keeping the warm air inside and preventing the cold air from entering inside the kennel/living area 102. Once the dog exit the kennel/living area 102, the vinyl flap door 312 comes back to the closing position. The vinyl flap door 312 is made of transparent material to allow the sunlight to enter inside the kennel dog house 102. The vinyl flap door 312 enables the dog to view the outside space and dog run from inside the kennel dog house 102. The front side wall 302 comprises a first vent 314. The rear side wall 304 comprises a second vent 316. The first vent 314 and the second vent 316 are arranged and configured to provide a cross ventilation in the kennel/living area 102. The first vent 314 and the second vent 316 are kept closed during the winter and opened during the summer.

The right side wall 306 comprises an electrical chord hole 324 at one corner. The electrical chord hole 324 allows an electrical chord of the heater to exit directly from the side wall of the kennel/living area 102. The left side wall 308 comprises a personal access door 108. The personal access door 108 is nearly equal in size to that of the left side wall 308. Thus the personal access door 108 enables an individual to have a full access to the inside area of the kennel/living area 102. As the kennel/living area 102 is in an elevated condition from the ground level, the personal access door 108 is also kept at an elevated condition and is positioned at a preset height. Hence, the individual is enabled to reach the things arranged inside kennel/living area 102 by standing on foot, thereby eliminating a need for bending down or standing on knees. Further, the personal access door 108 enables the individual to check the presence of dog inside the kennel/living area 102 and to make arrangements for cleaning the dirt in the kennel/living area 102 properly. The four sides of the wall, the base 320 and the roof 110 are covered with an insulation material 318 to sustain an optimum comfortable temperature in the kennel/living area 102.

Further, the lower portion of the base 320 of the kennel/living area 102 is configured to act as an extended dog run. The dog run of the modular dog house is extended underneath the kennel/living area 102. The dog run is extended by attaching the panels on the steel frame under the left side wall 306, the right sidewall 308 and the rear side wall 304. The panels are welded wire gauge mesh 322, thereby making the panels chew resistant. The extended run under the kennel/living area 102 is configured to provide shade and shelter from the sun. The dog run is extended underneath the kennel/living area to prevent the water and dirt from seeping inside the kennel/living area 102.

According to an embodiment of the present invention, the modular dog house is converted to a rabbit hutch and a small pet animal house by converting the ramp attached to the panel into multi layer steps. The small pet animals including rabbit is enabled to use the stair case with the plurality of steps to climb up to the porch and climb down to the run.

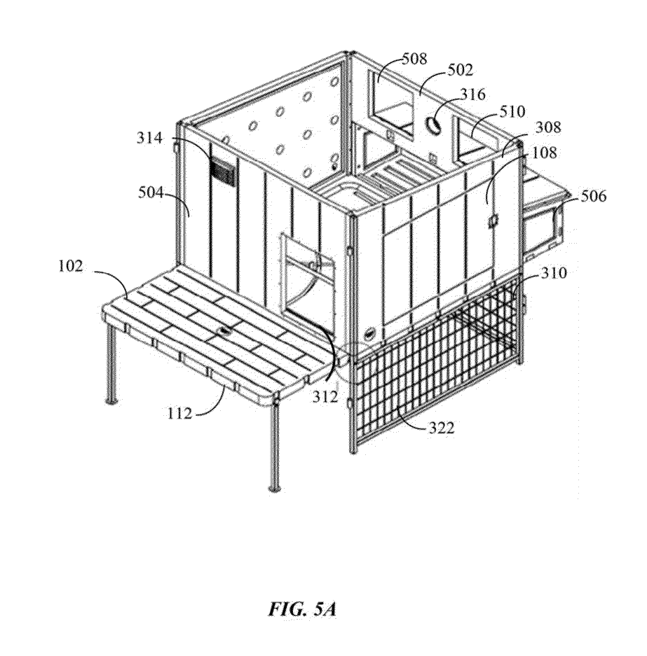

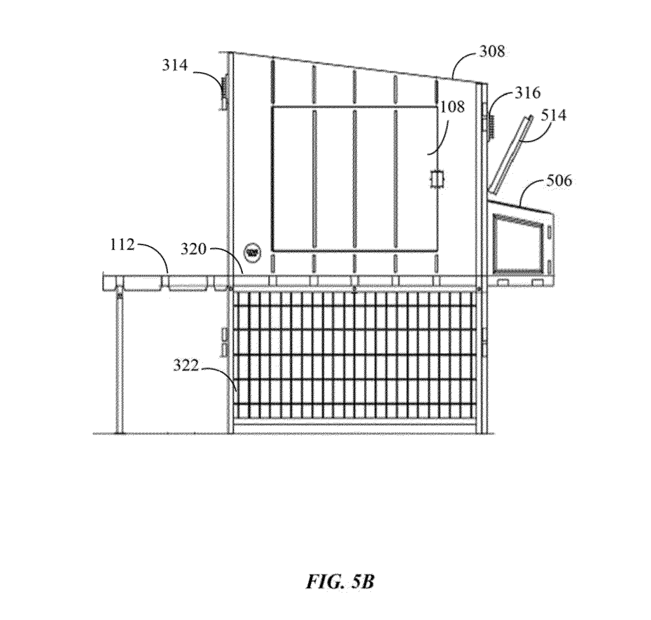

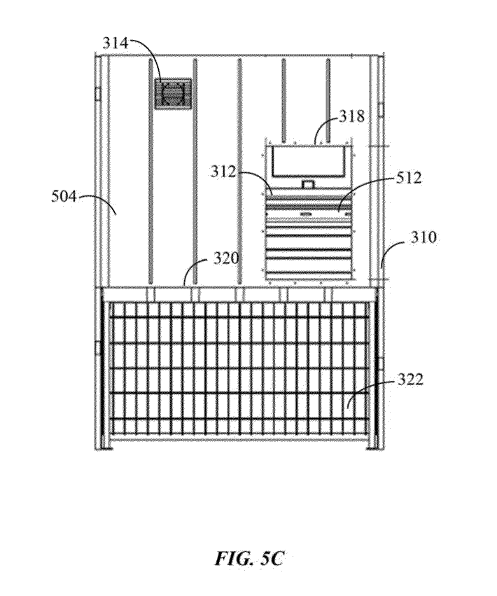

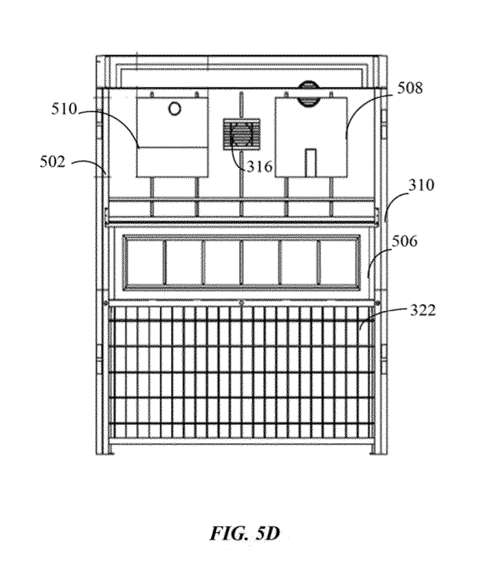

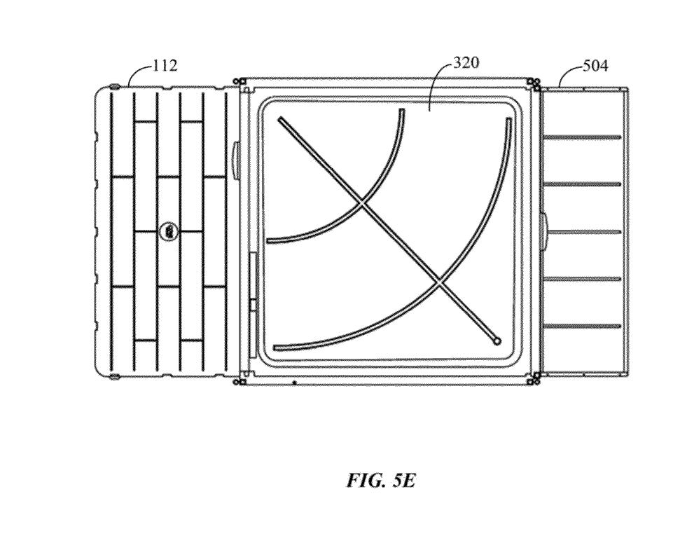

FIG. 5A illustrates the top side perspective view of a chicken coop, according to one embodiment herein. FIG. 5B illustrates the side view of a chicken coop, according to one embodiment herein. FIG. 5C illustrates the front side view of a chicken coop, according to one embodiment herein. FIG. 5D illustrates the rear side view of a chicken coop, according to one embodiment herein. FIG. 5E illustrates the top side view of a chicken coop, according to one embodiment herein. According to another embodiment of the present invention, the modular dog house is converted to a chicken coop by adding predetermined features to the modular dog house. With respect to FIG. 5A-FIG. 5E, the chicken coop comprises a rear side wall 502, a front side wall 504, a right side wall 306 and a left side wall 308. The chicken coop further comprises a base 320, a porch 112 and a roof 110. The right side wall 306 and the left side wall 308, the base 320, the porch 112 and the roof 110 of the chicken coop are identical to that of kennel/living area in the modular dog house. However, the rear side wall of the modular dog house is replaced with a rear side wall 502. The rear side wall 502 of the chicken coop comprises a nesting box 506, a first window 508 and a second window 510. The nesting box 506 is attached to the nesting cover 514 on the rear wall 502. The first window 508 and the second window 510 are configured to allow the light entry into the chicken coop. The front side wall 502 comprises a roosting bar support on the rear side. Further, the chicken coop comprises roosting bars attached to the roosting bar support.

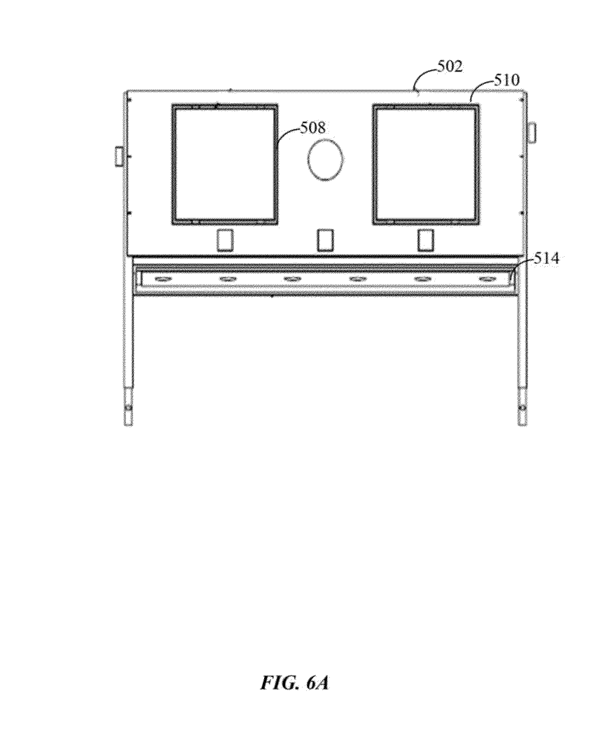

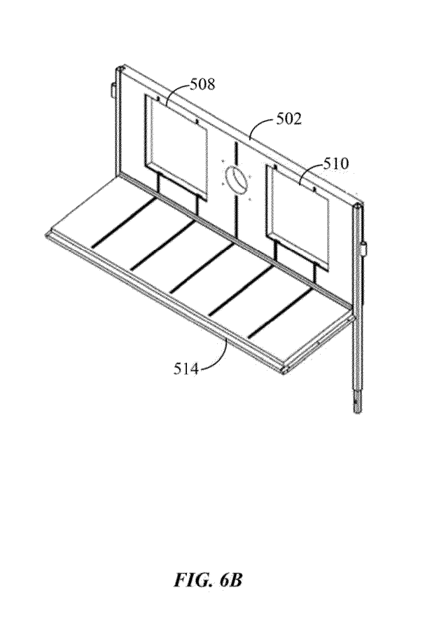

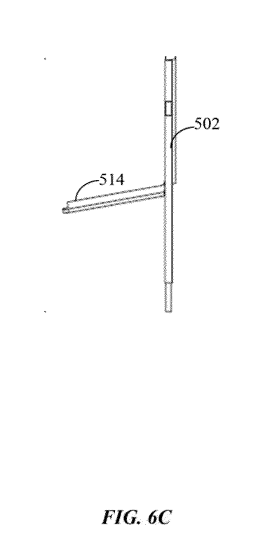

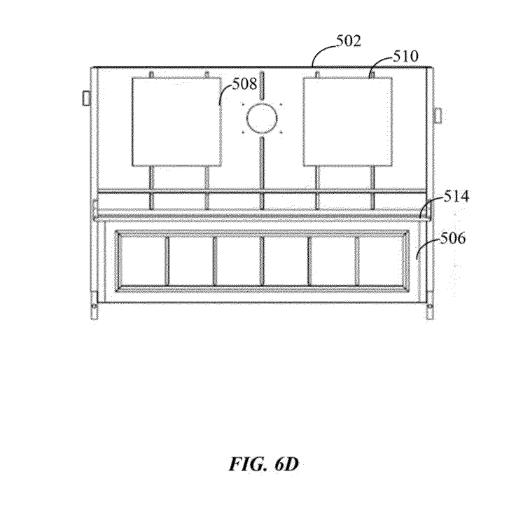

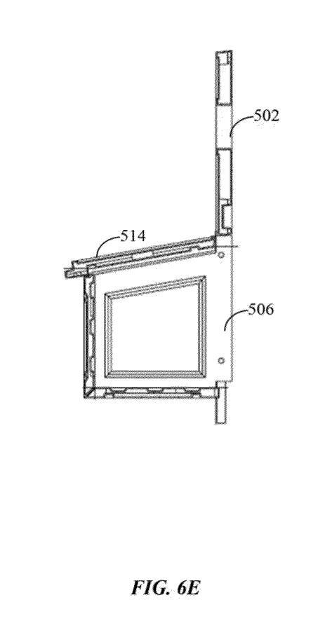

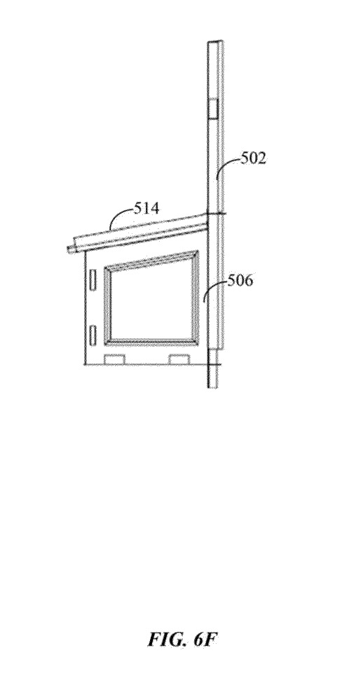

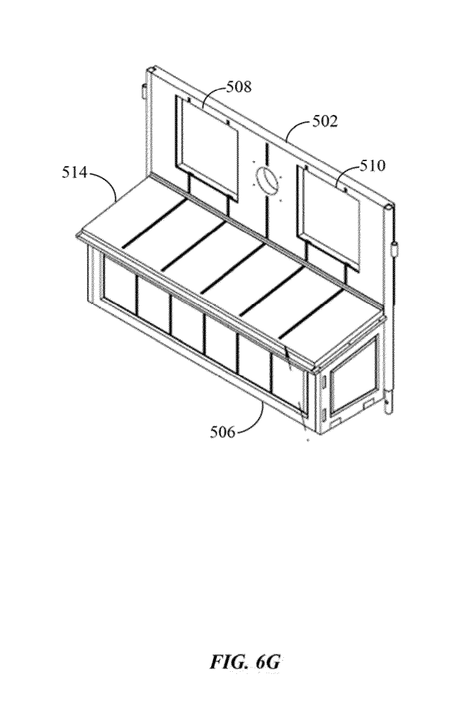

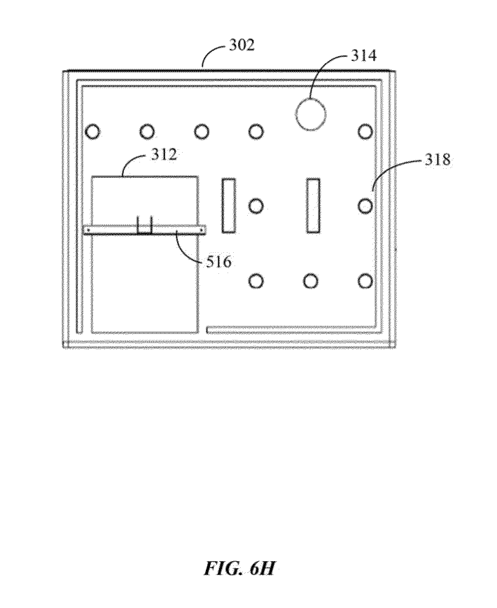

FIG. 6A illustrates the front view of the rear side wall of a chicken coop, according to one embodiment herein. FIG. 6B illustrates the front side view of the rear side wall of a chicken coop, according to one embodiment herein. FIG. 6C illustrates the side view of the rear side wall of a chicken coop, according to one embodiment herein. FIG. 6D illustrates the front view of the rear side wall with nesting box in a chicken coop, according to one embodiment herein. FIG. 6E illustrates the side view of the rear side wall with a nesting box in a chicken coop, according to one embodiment herein. FIG. 6F illustrates the side view of the rear side wall with a nesting box in a chicken coop, according to one embodiment herein. FIG. 6G illustrates the front side view of the rear side wall with a nesting box in a chicken coop, according to one embodiment herein. FIG. 6H illustrates the rear view of the front side wall of a chicken coop, according to one embodiment herein.

With respect to FIG. 6A-FIG. 6H, With respect to FIG. 5A-FIG. 5E, the chicken coop comprises a rear side wall 502, a front side wall 504, a right side wall 306 and a left side wall 308. The chicken coop further comprises a base 320, a porch 112 and a roof 110. The right side wall 306 and the left side wall 308, the base 320, the porch 112 and the roof 110 of the chicken coop are identical to that of kennel/living area in the modular dog house. However, the rear side wall of the modular dog house is replaced with a rear side wall 502. The rear side wall 502 of the chicken coop comprises a nesting box 506, a first window 508 and a second window 510. The nesting box 506 is attached to the nesting cover 514 on the rear wall 502. The first window 508 and the second window 510 are configured to allow the light entry into the chicken coop. The front side wall 502 comprises a roosting bar support on the rear side. Further, the chicken coop comprises roosting bars attached to the roosting bar support. The front side wall 504 comprises a roosting bar support 516 on the rear side. The remaining features of the front housing side wall 504 are identical to the front housing side wall 302 of the modular dog house.

Therefore the modular dog house in the present invention provides a safe and secure environment for the pet animals. The elevated structure of the modular dog house provides the dog with a clean and hygienic housing to live in by preventing water and dirt seeping in during rain. Further, the elevated structure provides the dogs with a dog run expanded/extended underneath the modular dog house, thereby increasing a play area of the dogs. The modular dog house is large in size to accommodate the breed of dogs with a large size as wells as two to three dogs if necessary. Therefore, the area of the modular dog house is almost doubled with the use of the elevated structure.

The personal access door enables an individual to clean the kennel/living area in the modular dog house easily and provides full access to the materials inside the kennel/living area. Further, the modular dog house including the frames for the kennel/living area and the dog run is made of steel bars. The steel frame provides durable, chew resistant, heavy duty dog house that last for a life time. Further the walls of the kennel/living area is made of maintenance free structures such as polyethylene plastic, thereby making the dog house rust-resistant, and to withstand any temperature, climate and weather conditions. Further, the dog run is provided with a roofing to cover either a portion or the entire area of the dog run. The roofing of the dog run prevents the dog from jumping and climbing out of the modular dog house.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all of the generic and specific features of the embodiments described herein and all the statements of the scope of the embodiments which as a matter of language might be said to fall there between.

What is claimed is:

1. A modular dog house comprising:
a kennel/living area positioned at a height from a ground level, wherein the kennel/living area comprises a front side wall, a rear side wall, a left side wall, a right side wall, a porch, a base and a roof;
a dog run attached to the front side of the kennel/living area, wherein the dog run is extended underneath the kennel/living area;
a ramp equipped with cleats, wherein the ramp is configured for providing grip to climb up to the porch, and wherein one end of the ramp is attached to the porch and other end of the ramp is attached to the ground;
a personal access door placed at the left side wall for providing an access to an inside area of the kennel/living area, wherein a size of the personal access door is nearly equal to a size of the left side wall; and
a vinyl flap door placed at the front side wall for enabling the dog to move to the porch and the dog run.

2. The modular dog house in claim 1, wherein the kennel/living area is filled with insulation arranged on an inner surface of the front side wall, the rear side wall, the left side wall, the right side wall, the base and the roof for providing an optimum temperature level inside the kennel/living area.

3. The modular dog house in claim 1, wherein the kennel/living area is supported on a steel frame.

4. The modular dog house in claim 1, wherein the dog run is built by attaching a plurality of panels, and wherein the plurality of panels are made of welded wire gauge mesh on both sides of the front housing side wall.

5. The modular dog house in claim 1, wherein the dog run is expanded/extended by attaching a plurality of additional panels to the existing dog run.

6. The modular dog house in claim 1, wherein the roof is a simulated shingled roof with a steep pitch for providing a drainage of snow and rain.

7. The modular dog house in claim 1, wherein the front side wall comprises a first vent and the rear side wall comprises a second vent, wherein the first vent and the second vent are configured to provide a cross ventilation inside the kennel/living area.

8. The modular dog house in claim 1, wherein the dog run is extended underneath the kennel/living area to provide an extra square footage.

9. The modular dog house in claim 1, wherein the vinyl flap door is a transparent flap door configured to allow entry of sunlight into the kennel/living area.

10. The modular dog house in claim 1, wherein the vinyl flap door is attached with a magnetic strip at the bottom to ensure a closing of the vinyl flap door.

11. The modular dog house in claim 1, wherein the living area is converted to small pet animal house by changing the ramp with a stair case.

12. The modular dog house in claim 1, wherein the living area is converted to a chicken coop by changing the rear side wall with a rear side wall having preset features.
